(19) United States
(12) Patent Application Publication
(10) Pub. No.: US 2020/0396339 A1
(43) Pub. Date: Dec. 17, 2020

(54) MULTI EVENT NOTIFICATION FOR THE SIGHT AND HEARING-IMPAIRED

(71) Applicant: JULIO ALFONSO RODRIGUEZ, CAPE CORAL, FL (US)

(72) Inventor: JULIO ALFONSO RODRIGUEZ, CAPE CORAL, FL (US)

(21) Appl. No.: 16/437,736

(22) Filed: Jun. 11, 2019

(51) Int. Cl. H04M 11/04; G06F 9/54; G08B 5/38; G08B 25/10

(52) U.S. Cl. CPC H04M 11/04; G08B 25/10; G08B 5/38; G06F 9/542

(57) ABSTRACT

An event notification system can include first and signalers and a flasher. Each signaler can wirelessly transmit an identifier associated therewith. The flasher can receive an identifier from each signaler indicating respective events, and cause a light source to display from at least two colors a particular color associated with the identifier. The at least two colors are red-green and/or blue-yellow color-blind friendly.

### FIELD OF THE INVENTION

The present invention relates to event notification devices, and more specifically, to event notification devices for those with physical disabilities.

### BACKGROUND OF THE INVENTION

An event notification device can notify persons of events, such as a predetermined time (via an alarm clock or timer), the presence of a person (such as a door bell), and a request for communications (a telephone bell). Notification systems for the hearing-impaired have focused on providing light-based notifications. However, such systems have failed to account for the hearing impaired who are also color-blindness.

### SUMMARY OF THE INVENTION

It is an object of the present invention to provide a multi event notification system for the sight and hearing-impaired.

It is another object of the present invention to provide a corresponding method of providing multi event notification for the sight and hearing-impaired.

In an exemplary embodiment, the present invention can include a first signaler, a second signaler, and a flasher.

In an exemplary aspect, a first signaler can include a first wireless transmitter configured to send a first identifier associated with the first signaler, and a first actuator configured to cause the first wireless transmitter to wirelessly send the first identifier.

In another exemplary aspect, a second signaler can include a second wireless transmitter configured to send a second identifier associated with the second signaler, and a second actuator configured to cause the second wireless transmitter to wirelessly send the second identifier.

In another exemplary aspect, a flasher can include a wireless receiver, a light emitting device configured to selectively display at least two different colors, and a computer memory having stored therein a first signaler profile associated with the first identifier and including a first color of the at least two colors, and a second signaler profile associated with the second identifier and including a second color of the at least two colors.

In a further exemplary aspect, upon receipt of the first identifier, said flasher can reference the first color based on the first identifier and cause the light emitting device to display the first color, and upon receipt of the second identifier, said flasher can reference the second color based on the second identifier and cause the light emitting device to display the second color.

In still another exemplary aspect, the first and second colors can be red-green color-blind friendly and/or blue-yellow color-blind friendly.

In still further exemplary aspects, the first and second colors can be one or more of protanomaly friendly, protanopia friendly, deuteranomaly friendly, deuteranopia friendly, tritanomaly friendly, and tritanopia friendly.

In another exemplary aspect, the first and/or second actuator can be a manual switch configured to actuate upon closing of the switch.

In yet another exemplary aspect, the first and/or second actuator can be an electrical interface configured to actuate upon receipt of an incoming electrical signal.

In still yet another exemplary aspect, at least one of said first and second signalers can include a color toggle button configured to send a color toggle signal.

In still yet a further exemplary aspect, a flasher can further include an audible device configured to selectively produce at least two different sounds, the first signaler profile further including a first sound of the at least two sounds, the second signaler profile further including a second sound of the at least two sounds, and upon receipt of the first identifier, said flasher references the first sound based on the first identifier and causes the audible device to produce the first sound, and upon receipt of the second identifier, said flasher references the second sound based on the second identifier and causes the audible device to produce the second sound.

### BRIEF DESCRIPTION OF THE DRAWINGS

FIG. 1 illustrates a high-level logical representation of a multi event notification system having a flasher and first and second signalers.

FIG. 2a illustrates an exemplary first signaler embodied as a wireless door bell and having a first wireless transmitter, a first actuator, and an optional first color toggle button.

FIG. 2b illustrates an exemplary second signaler embodied as a telephone signaler and having a second wireless transmitter, a second actuator, and an optional second color toggle button.

FIG. 2c illustrates an exemplary flasher having a wireless receiver, a light emitting device, a computer memory, and an optional audible device.

FIG. 2a illustrates an exemplary signaler having a first wireless transmitter, a first actuator, and an optional first color toggle button.

FIG. 3 illustrates exemplary data storage of computer memory 134 can be provided as any type of memory device that is functionally consistent with the present

FIG. 4 illustrates an exemplary user interface that can include a power interface, a low/bright light source switch, a color cycle button, a volume cycle button, and a sound cycle button.

FIG. 5 illustrates an exemplary method steps of multi event notification.

### DETAILED DESCRIPTION

It should be noted that this disclosure includes a plurality of embodiments, each having a plurality of elements, aspects, steps, and configurations, and such elements, aspects, steps, and configurations need not necessarily be interpreted as being conjunctively required by one or more embodiments of the present invention. Rather, all combinations of all elements, aspects, steps, and configurations described herein can enable a separate embodiment of the present invention, which may be claimed with particularity in the present or one or more future filed Non-Provisional Patent Applications. Moreover, any particular structure, arrangement, step, and/or functional logic disclosed herein, whether expressly or implicitly, are to be construed strictly as illustrative and enabling, and not necessarily limiting. Therefore, it is expressly set forth that such structure, step, arrangement, and functional logic, independently or in any combination thereof, are merely illustratively representative of one or more elements, steps, and/or aspects of one or more embodiments of the present invention and are not to be construed as necessary in a strict sense.

Further, to the extent the same element, step, or aspect is defined differently anywhere within this disclosure, whether expressly or implicitly, or individually or in combination with any another element, step, or aspect, the broader definition is to take absolute precedence, with the distinctions encompassed by the narrower definition to be strictly construed as optional.

Moreover, it will be apparent to one of ordinary skill in the art that the present invention can be provided with any desired material and configuration desired insofar as the same is functionally consistent with the present invention. Further, any required hardware elements for each embodiment described herein are to be perceived in a minimalistic manner. Accordingly, one of ordinary skill in the art is directed to interpret the required hardware for each embodiment as the minimum hardware elements required to effectuate each aspect of the invention, with any additional hardware illustratively shown and/or described conjunctively herein as being strictly optional for that respective embodiment.

Illustratively, perceived benefits of the present invention can include functional utility, whether expressly or implicitly stated herein, or apparent herefrom. However, it is expressly set forth that these benefits are not intended as exclusive. Therefore, any explicit, implicit, or apparent benefit from the disclosure herein is expressly deemed as applicable to the present invention. Exemplary functional utility provided by a device controller disclosed herein includes enforcement of at least one feature of the security feature set described herein, and can include any additional or alternative utility apparent herefrom.

An exemplary benefit of the present invention includes providing multi event notification for the hearing and/or sight-impaired. In particular, to provide plural notifications, each representing different events, the present invention accounts for the color-blind by utilizing color-blind friendly color schemes to allow those with such impairment the ability to distinguish between colors, and therefore, different events.

Color-blindness can be categorized as Red-Green Color Blindness, Blue-Yellow Color Blindness, and Complete Color Blindness. The present invention particularly relates to Red-Green and Blue-Yellow Color Blindness, and ensures that those having a hearing disability and a form of the above-noted color blindness are provided with multi event notification.

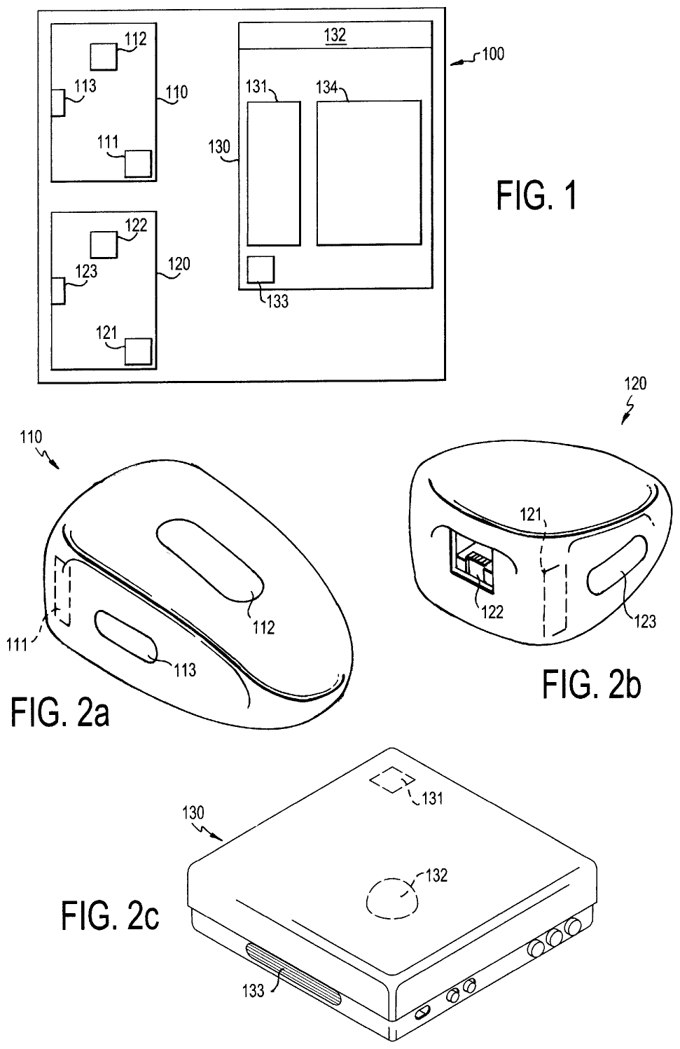

FIG. 1 illustrates a high-level logical representation of the present invention, which can be embodied in a multi event notification system 100 that can include a first signaler 110, a second signaler 120, and a flasher 130.

FIG. 2a illustrates an exemplary first signaler 110 that can include a first wireless transmitter 111 configured to send a first identifier (not shown) associated with the first signaler, a first actuator 112 configured to cause the first wireless transmitter to wirelessly send the first identifier, and an optional first color toggle button 113, which can cause the first wireless transmitter to wirelessly send a first color toggle signal (not shown).

FIG. 2b illustrates an exemplary second signaler 120 that can include a second wireless transmitter 121 configured to send a second identifier (not shown) associated with the second signaler, a second actuator 122 configured to cause the second wireless transmitter to wirelessly send the second identifier, and an optional second color toggle button 123, which can cause the second wireless transmitter to wirelessly send a second color toggle signal (not shown).

According to the present invention, first and second wireless transmitters 111, 121 can be provided as any type of wireless transmitter that is functionally consistent with the present invention. Further, first and second identifiers can be provided as any type of data instance that identifies first and second signalers 110, 120, respectively, such that receipt of a particular identifier will identify the particular signaler as the sender. For example and not in limitation, identification can be effectuated via the data instance itself or via the frequency or signal strength at which it is sent. Further, first and second actuators 113, 123 can be provided as any type of mechanical and/or electrical structure that is functionally consistent with the present invention. For example and not in limitation, FIG. 2a illustrates first signaler 110 as a door bell, in which case first actuator 112 can be provided as a switch (e.g., a button) that can, when closed, cause first wireless transmitter 111 to wirelessly send the first identifier; whilst FIG. 2b illustrates second actuator 122 as a RJ-11 telephone jack that can cause second wireless transmitter 121 to send the second identifier, when an incoming ringing voltage (e.g., from a PBX or CO) is received by the second actuator. Further, optional first and second color toggle buttons 113, 123 can be respectively provided as a switch, which can cause first and second color toggle signals to be sent.

FIG. 2c illustrates an exemplary flasher 130 that can include a wireless receiver 131, a light emitting device 132, an optional audible device 133, and a computer memory 134. In an exemplary aspect, wireless receiver 131 can be provided as any type of receiver that is functionally consistent with the present invention. In another exemplary aspect of the present invention, light emitting device 132 can be provided as any type of light emitting device that is functionally consistent with the present invention. While plural types of lighting technologies exist, those based on light emitting diodes can be advantageous due to their lower power requirements and life span. Notably, as further described herein, light emitting device 132 can be configured to selectively display at least two different colors that are color-blind friendly. Further, light emitting device 132 can be disposed below a transparent and/or translucent material, which can provide a light-pipe feature. In a further exemplary aspect, optional audible device 133 can be provided as a speaker for producing an audible sound.

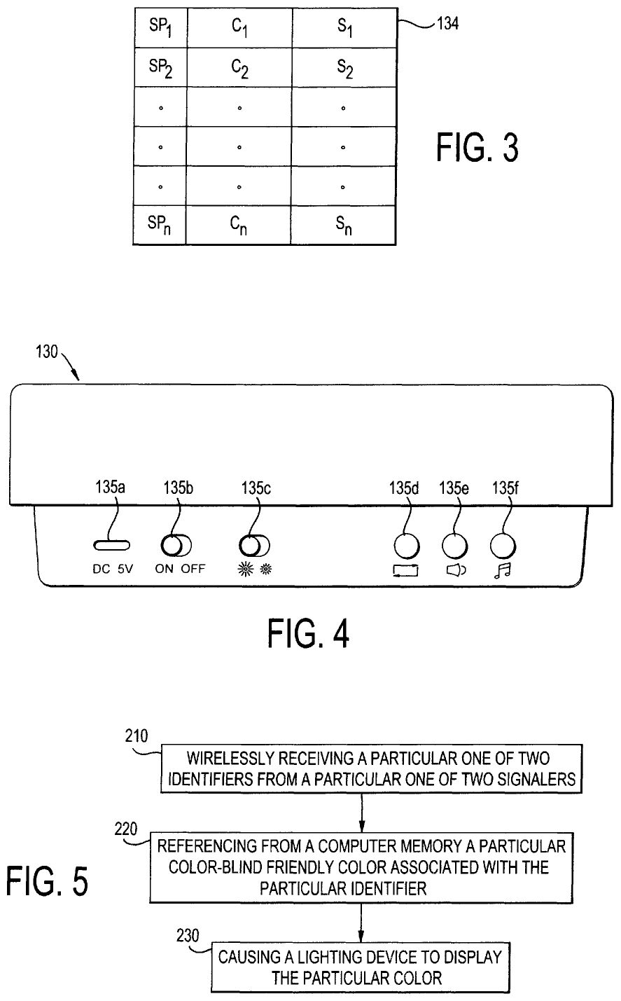

FIG. 3 illustrates exemplary data storage within computer memory 134, which can be provided as any type of memory device that is functionally consistent with the present invention, such as an EPROM for example and not in limitation. As illustrated, computer memory 134 can have stored therein a plurality of signaler profiles (SP1-SPn, for n>1) including a first signaler profile SP1 and second signaler profile SP2. As further illustrated, first and second signaler profiles SP1, SP2 can respectively include designated colors C1, C2 and optionally can include designated sounds S1, S2.

FIG. 4 illustrates an exemplary flasher 130 having an optional exemplary interface including a power interface 135a for connecting an external power source, an on/off switch 135b that powers flasher 130 on or off, a low/bright light source switch 135c that modifies the brightness of light emitting device 132, a color cycle button 135d for cycling through colors of a stored color set, a volume cycle button 135e for cycling through volume levels of optional audible device 133, and a sound cycle button 135f for cycling through sounds of a sound set.

The following is an exemplary operation of the present invention, with first signaler 110 being a door bell and second signaler being a telephone signaler: Actuation of first actuator 112 causes first wireless transmitter 111 to send the first identifier. Upon receipt of the first identifier by wireless receiver 131, flasher 130 references first color C1 from computer memory 134 based on the first identifier, and causes light emitting device 132 to display the first color, such that one who is color-blind, as defined below, can visually perceive as representing a door bell signal and differentiate the same from second color C2. Likewise, as second color C2 can be differentiated from first color C1, the displaying of the second color can be recognized as an incoming telephone call. Notably, where sound notifications are optionally included, flasher 130 can similarly reference corresponding sounds SN from computer 134 and cause optional audible device 133 to produce a sound corresponding to a received identifier.

Red-Green Color Blindness arises from the loss or limited function of red cone or green cone photopigments, and includes four subtypes: Protanomaly, in which the colors red, orange, and yellow appear green or greener; Protanopia, in which the color red appears black, and certain shades of orange, yellow, and green appear yellow; Deuteranomaly, in which the colors yellow and green appear red or redder, and the color violet appears blue; and Deuteranopia, in which the color red appears brownish-yellow, and greens appear beige.

Blue-yellow color blindness arises from the loss of limited function of blue-cone photopigments, and includes two subtypes: Tritanomaly, in which the color blue appears green or greeer, and the colors yellow and red appear pink; and Tritanopia, in which the color blue appears green, and the color yellow appears violet or light grey.

Accordingly to the present invention, for first and second colors C1, C2 to be color-blind friendly, they are colors that are distinguishable from each other for one being color-blind as per at least one of the above-cited types and subtypes.

According to the present invention, first and second colors C1, C2 are Protanomaly friendly upon condition that if either the first or second color is red, orange, yellow, or green, then the other color is not red, orange, yellow, or green.

According to the present invention, first and second colors C1, C2 are Protanopia friendly upon condition that if either the first or second color is red or black, then the other color is not red or black, and if either the first or second color is orange, yellow, or green, then the other color is not orange, yellow, or green.

According to the present invention, first and second colors C1, C2 are Protanopia friendly upon condition that if either the first or second color is red or black, then the other color is not red or black, and if either the first or second color is orange, yellow, or green, then the other color is not orange, yellow, or green.

According to the present invention, first and second colors C1, C2 are Deuteranomaly friendly upon condition that if either the first or second color is yellow, green, or red, then the other color is not yellow, green, or red, and if either the first or second color is violet or blue, then the other color is not violet or blue.

According to the present invention, first and second colors C1, C2 are Deuteranopia friendly upon condition that if either the first or second color is red or brownish-yellow, then the other color is not red or brownish-yellow, and if either the first or second color is green or beige, then the other color is not green or beige.

According to the present invention, first and second colors C1, C2 are Tritanomaly friendly upon condition that if either the first or second color is blue or green, then the other color is not blue or green, and if either the first or second color is yellow, red, or pink, then the other color is not yellow, red, or pink.

According to the present invention, first and second colors C1, C2 are Tritanopia friendly upon condition that if either the first or second color is blue or green, then the other color is not blue or green, and if either the first or second color is yellow, violet, or light grey, then the other color is not yellow, violet, or light grey.

Optionally, memory 134 can further have stored therein color-blind friendly sets of colors, which adhere to one or more of the above defined color-blind friendly rule sets. Accordingly, at least one of first and second signalers 110, 120 can optionally and respectively include first and second color toggle buttons 113, 123, which when activated can cause a corresponding wireless transmitter to send a corresponding color toggle signal along with a corresponding identifiers. Upon receipt, flasher 130 can modify a stored color CN corresponding to the received identifier to another color within a color-blind friendly color set.

Also optionally, as noted above, computer memory 134 can have stored therein sets of sounds, which can be selected for production as event notifications.

FIG. 5 illustrates an exemplary method of multi event notification, which can include the steps of wirelessly receiving a particular one of two identifiers from a particular one of two signalers (step 210); referencing from a computer memory a particular color-blind friendly color associated with the particular identifier (step 220); and causing a light emitting device to display the particular color (step 230). In exemplary aspects, such a method can be performed via any one or more embodiments of a multi event notification system as described herein.

It will be apparent to one of ordinary skill in the art that the manner of making and using the claimed invention has been adequately disclosed in the above-written and attached description of the exemplary embodiments and aspects of the present invention.

It should be understood, however, that the invention is not necessarily limited to the specific embodiments, aspects, arrangement, steps, and components shown and described above, but may be susceptible to numerous variations within the scope of the invention. For example and not in limitation, while two signalers and a single flasher have been exemplarily described, the present invention can be implemented with as many signalers and flashers desired, insofar as functionally consistent. Further, identifiers need not be different data instances for unique association with signalers, but rather can be the same signals transmitted at unique frequencies or patterns. Moreover, while the present invention contemplates wireless communications, wired communications are considered equivalents to the extent functionally consistent with the present invention.

Therefore, the specification and drawings are to be regarded in an illustrative and enabling, rather than a restrictive, sense.

Accordingly, it will be understood that the above description of the embodiments of the present invention are susceptible to various modifications, changes, and adaptations, and the same are intended to be comprehended within the meaning and range of equivalents apparent to one of ordinary skill in the art.

Therefore, I claim:

1. A multi event notification system, comprising:
a first signaler having a first wireless transmitter configured to send a first identifier associated with said first signaler, and a first actuator configured to cause the first wireless transmitter to wirelessly send the first identifier;
a second signaler having a second wireless transmitter configured to send a second identifier associated with said second signaler, and a second actuator configured to cause the second wireless transmitter to wirelessly send the second identifier;
a flasher having a wireless receiver, a light emitting device configured to selectively display at least two different colors, a computer memory having stored therein a first signaler profile associated with the first identifier and including a first color of the at least two colors, and a second signaler profile associated with the second identifier and including a second color of the at least two colors;
wherein upon receipt of the first identifier, said flasher references the first color based on the first identifier and causes the light emitting device to display the first color, upon receipt of the second identifier, said flasher references the second color based on the second identifier and causes the light emitting device to display the second color, and the first and second colors are at least one of red-green color-blind friendly and blue-yellow color-blind friendly.

2. The notification system of claim 1, wherein the first and second colors are red-green color-blind friendly.

3. The notification system of claim 1, wherein the first and second colors are blue-yellow color-blind friendly.

4. The notification system of claim 1, wherein the first and second colors are protanomaly friendly.

5. The notification system of claim 1, wherein the first and second colors are protanopia friendly.

6. The notification system of claim 1, wherein the first and second colors are deuteranomaly friendly.

7. The notification system of claim 1, wherein the first and second colors are deuteranopia friendly.

8. The notification system of claim 1, wherein the first and second colors are tritanomaly friendly.

9. The notification system of claim 1, wherein the first and second colors are tritanopia friendly.

10. The notification system of claim 1, wherein the first actuator is a manual switch configured to actuate upon closing of the switch.

11. The notification system of claim 10, wherein the second actuator is a telephone interface configured to actuate upon receipt of an incoming phone call signal.

12. The notification system of claim 1, wherein the second actuator is a telephone interface configured to actuate upon receipt of an incoming phone call signal.

13. The notification system of claim 1, wherein said flasher further includes an audible device configured to selectively produce at least two different sounds, the first signaler profile further including first sound of the at least two sounds, the second signaler profile further including a second sound of the at least two sounds, and upon receipt of the first identifier, said flasher references the first sound based on the first identifier and causes the audible device to produce the first sound, and upon receipt of the second identifier, said flasher references the second sound based on the second identifier and causes the audible device to produce the second sound.

14. A method of multi event notification using at least two color-blind friendly colors, comprising:
receiving a particular one of two identifiers from a particular one of two signalers;
referencing from a computer memory a particular one of the at least two color-blind friendly colors associated with the particular identifier; and
causing a light emitting device to display the particular color;
wherein the particular color is at least one of red-green color-blind friendly and blue-yellow color-blind friendly.

15. The method of claim 14, wherein the particular color is red-green color-blind friendly.

16. The method of claim 14, wherein the particular color is blue-yellow color-blind friendly.

17. The method of claim 14, wherein the particular color is protanomaly friendly.

18. The method of claim 14, wherein the particular color is protanopia friendly.

19. The method of claim 14, wherein the particular color is deuteranomaly friendly.

20. The method of claim 14, wherein the particular color is deuteranopia friendly.

21. The method of claim 14, wherein the particular color is tritanomaly friendly.

22. The method of claim 14, wherein the particular color is tritanopia friendly.
